(19) United States
(12) Patent Application Publication
(10) Pub. No.: US 2006/0107517 A1
(43) Pub. Date: May 25, 2006

(54) Method for the cold extrusion of bolts, in particular for fastening the cutting blades of mowers or the like

(76) Inventor: Alessandro Vescovini, Monfalcone (IT)

Correspondence Address: Charles Berman;Greenberg Traurig, Suite 400E, 2450 Colorado Avenue, Santa Monica, CA, 90404, US

(21) Appl. No.: 10/534,277

(22) PCT Filed: Sep. 8, 2004
(86) PCT No.: PCT/IT04/00484

§ 371 Date: May 6, 2005

(30) Foreign Application Priority Data
Sep. 9, 2003 (IT) VR2003A000108

(51) Int. Cl. B23P 13/04

(52) U.S. Cl. 29/558

(57) ABSTRACT

A method for producing metal parts such as special bolts (20) by means of cold extrusion in pressing dies comprises a first step of cutting to size a metal blank (30) to be modelled with predetermined dimensions, at least one step of cold pressing in a die in order to reduce one or more portions of the blank (30) to predetermined diameters, and a step of cold pressing in a die during which a coupling key (25) is formed on a portion (32) of the blank (30), the lateral surface (36) of the key protruding beyond the lateral surface of this portion (32), with respect to the longitudinal axis of the blank (30). The resulting product can be used in particular as a special bolt for the positive coupling of a mowing machine blade to a rotating plate in order to rotate the blade.

### TECHNICAL FIELD

This invention refers to a method for the cold extrusion of bolts.

In particular, this invention refers to a method for the cold extrusion of a bolt equipped with a key or lug for coupling the bolt to rotating mechanical parts such as, for example, cutting blades of mowing machines or the like.

The invention also refers to a bolt obtained by means of this method.

This invention can be applied in the field of the mechanical industry.

### BACKGROUND ART

During the assembly of rotating mowing machines, special bolts are often used in order to rigidly fix the cutting blades to a rotating plate in turn connected to the motor of the machine.

An example of this nature is illustrated in FIG. 1, which shows a pair of bolts 10, 10′, a pair of blades 50, 50′ and a rotating plate 60 belonging to a mowing machine known to the background art.

These special bolts comprise a first threaded portion, designed to be coupled to a corresponding blocking nut with the possible interposition of a washer, a second portion equipped with a key (or lug) for centering and positioning the bolt with respect to the rotating plate, a third portion, whose diameter corresponds to the diameter of the hole in the blade, and a head designed to press against the body of the blade.

Special bolts of the type described above are generally obtained by means of cold extrusion methods on multipress machines, starting from blanks of steel bars placed inside appropriate pressing dies.

In this context, it should be noted that in the solutions known to the background art, the key (or lug) is obtained by caulking after the pressing of the body of the bolt.

In practice, the bolt body is clamped inside a caulking machine which acts on a lateral portion of the bolt shank in order to form a pair of symmetrical key elements that rise from the bolt shank, forming a corresponding pair of notches within the shank beside the key elements.

This solution, well known to the background art, is illustrated in FIGS. 2 and 2a which show a special bolt 10 with a first threaded portion 11, a collar 12, a head 13, a central portion 14 with a respective pair of symmetrical key portions 15, 15′ and a pair of notches 16, 16′ each of which is positioned alongside a respective key portion 15, 15′.

The key (or lug) obtained by caulking projects radially from the side of the central portion 14 of the bolt 10, and plays an important role of anti-unbolting in the mechanical coupling of the blades to the rotating plate.

It must, in fact, ensure positive coupling of the bolt/blade assembly to the plate and the key must therefore be completely reliable in terms of mechanical features in order to guarantee the safety of those using the mowing machines.

The technical solution described above presents a number of drawbacks and disadvantages.

From the technical-economic point of view, the caulking operation which leads to the formation of the key (or lug) on the body of the special bolt represents an additional operation with respect to the extrusion of the bolt body and which requires a specialised machine for this operation alone.

This therefore leads to an additional cost.

Furthermore, currently available caulking machines are not able to guarantee that all the machined bolts are equipped with a key that is geometrically constant and always protrudes beyond the side of the bolt body.

In other words, the caulking machines known to the background art cannot ensure that the positive coupling required between the bolt/blade system and the rotating plate of the mowing machine is always obtained or is consistently obtained.

In addition, the operation of flattening the key by caulking does not follow the direction of the steel fibres and tends to create surface tension and fragility up to the point of triggering microfissures between the surface of the shank diameter and the caulked key, these, microfissures being difficult to verify and thus increasing the risk of possible bolt fixing grip problems.

The denser hatched section in the upper part of FIG. 2a illustrates the compression of the fibres in the caulked area.

Moreover, the mechanical stress to which the steel of the bolt body is subjected during caulking and formation of the two symmetrical key portions is considerable, and cases have occurred in which the key portions snapped off during caulking or, even worse, during the use for which these bolts are designed.

These aspects are extremely important from the safety point of view, since a failed positive coupling between the bolt/blade unit and the rotating plate can lead to an inopportune rotation of the blades and even to detachment of the blades from the rotating plate during use of the mowing machine, with possible serious consequences for the user and anyone close to the machine.

### DESCRIPTION OF THE INVENTION

This invention proposes to overcome the drawbacks and disadvantages typical of the background art, and thus to provide a method for the production of special bolts, in particular for mowing machines, that allows the mass production of special bolts equipped with a built-in key (or lug) for coupling with other mechanical elements, the key being obtained directly by cold pressing and whose presence is guaranteed on all the pieces produced.

From a careful metallographic analysis of the arrangement of the fibres it can be seen that the key obtained by cold extrusion directly in the die is an integral part of the bolt shank. Therefore, appropriately designed radiuses are present between the diameter and the key, making the future coupling of the key superior in terms of quality with respect to the background art.

This is achieved by implementation of the features described in the main claim.

The dependent claims describe advantageous embodiments of the method according to the invention.

This invention also proposes to provide a special bolt, in particular a bolt designed to be used for coupling mechanical pieces such as the blades and rotating plate of a mowing machine.

This special bolt is described in the claim and its dependent claims.

### DESCRIPTION OF THE DRAWINGS

Other features and advantages of the invention will become evident on reading the following description of a form of embodiment of the invention, given as a non-binding example, with the help of the enclosed drawings, in which:

FIG. 1 is an exploded diagrammatic prospective view of the blade fixing area of a mowing machine known to the background art;

FIG. 2 is a front view of a special bolt known to the background art, in particular for the coupling of a blade/rotating plate unit of a mowing machine;

FIG. 2a is a cross-section of the special bolt in FIG. 2, corresponding to the central portion of the bolt shank;

FIG. 3 is a front view of a special bolt according to the invention;

FIG. 3a is a cross-section of the special bolt in FIG. 3, corresponding to the central portion of the bolt shank; and

FIGS. 4a to 4e show the side views of the various steps of the method according to the invention for obtaining a bolt shown in FIG. 3.

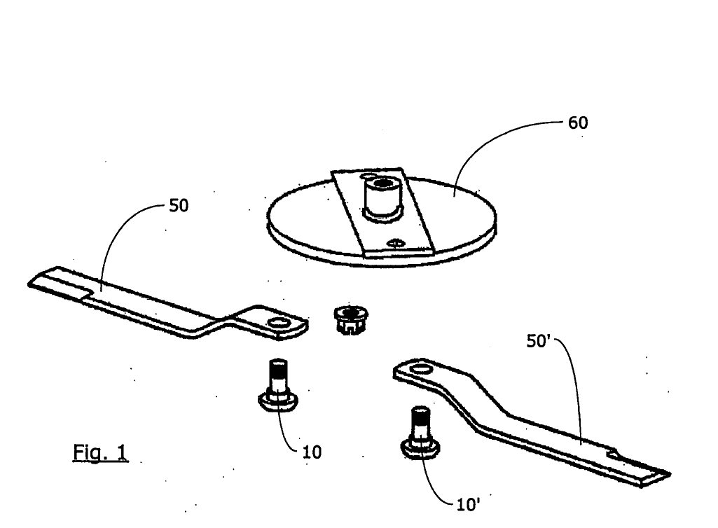

### DESCRIPTION OF ONE EMBODIMENT

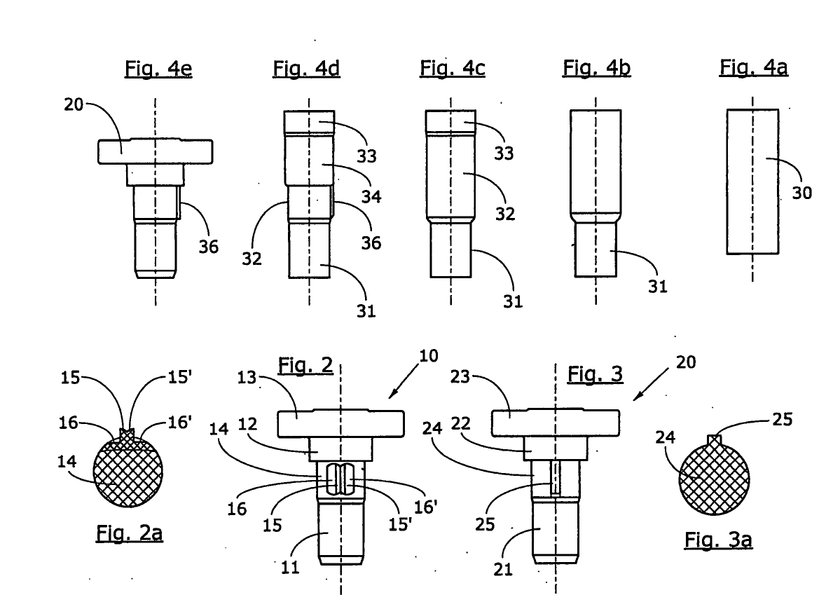

In FIGS. 3 and 3a, a special bolt 20, in particular a bolt designed to be used for coupling a blade to a rotating plate of a mowing machine, consists of a first threaded portion 21, a collar 22, a head 23 and a central portion 24 with a built-in key (or lug) 25 whose lateral surface 36 (see FIGS. 4d and 4e) protrudes externally with respect to the lateral surface of the central portion.

As already mentioned, the purpose of this built-in key (or lug) 25 is to provide a means of positive coupling between a blade/bolt unit and the rotating plate of a mowing machine.

The special bolt 20 is obtained by means of a cold extrusion process on a multipress, and the piece emerging from the last pressing die is subjected to a final roiling to produce the threading 21, without undergoing caulking of the key 25 as in the solutions know to background art.

In particular, FIG. 4a shows a steel bar blank 30 cut to size and ready for insertion in a first cold pressing die of a multipress machine.

FIG. 4b shows the result of the first pressing operation, during which the first portion 31, designed to be subsequently threaded, is formed.

In a second extrusion operation (FIG. 4c) a central portion 32 is formed, with a smaller diameter than the upper portion 33.

During the next step (FIG. 4d) the central portion is further divided into two parts 32 and 34, and the key (or lug) is formed at the same time, with its lateral surface 36 protruding with respect to the lateral surface of the portion 32.

In the last extrusion step (FIG. 4e) the complete special bolt is formed, as also shown in FIG. 2.

The formation of the key (or lug) 25 represents a delicate step in the bolt production process.

In order to prevent an untimely breakage of the pressing dies, it is in fact necessary to carefully monitor certain design parameters, such as for example the roughness of the equipment, the radius between the bolt shank and the key (or lug) and the geometric dimensions of the key itself.

The end result is, however, a bolt obtained by cold extrusion and which presents a built-in key (or lug) without requiring any further caulking operations.

At the same time, the method according to the invention guarantees the presence of the key (or lug) in: all the pieces produced since they must necessarily pass through a die which gives them their final shape, thus raising the quality level of the production with respect to the known methods.

The invention is described above with reference to a preferred embodiment.

It is nevertheless clear that the invention is susceptible to numerous variations that lie within its scope, in the framework of technical equivalents.

By way of example, it is clear that the materials used to produce the special bolts according to the invention can consist of various metals and their alloys.

Furthermore, although the invention is described with particular reference to bolts that can be used to couple blades and rotating plates of mowing machines, it is clear that the method according to the invention can be implemented for the production of bolts equipped with coupling keys with two or more extrusion diameters designed to achieve a positive coupling of pairs of any mechanical pieces, such as for example gear shafts, etc.

1. A method for producing special bolts by means of cold extrusion in pressing dies, comprising:
cutting to size, a metal blank to be modelled with predetermined dimensions; cold pressing in a die in order to reduce one or more portions of the blank to predetermined diameters; and
colder pressing in a die during which a coupling key is formed on a portion of the blank, wherein the lateral surface of the key protrudes beyond the lateral surface of the portion of the blank, with respect to the longitudinal axis of the blank.

2. The method of claim 1, further comprising the step of cold pressing in a die, during which a collar and a head above the collar are formed on the blank.

3. The method of claim 1, wherein at least one portion of the blank is subjected to rolling in order to produce the treading, following the steps of cold pressing in dies.

4. The method of claim 1, wherein the blank is made from metal.

5. The method of claim 4, wherein the die is made from steel or widia.

6. A metal element for coupling mechanical pieces comprising:
a first portion with a first predetermined diameter;
a second portion with a second predetermined diameter larger than the first diameter; and
a third portion with a third predetermined diameter larger than the second diameter, wherein the second portion presents a key or lug whose lateral surface protrudes beyond the surface of the second portion with respect to the longitudinal axis of the metal element.

7. The metal element of claim 6, wherein the element further comprises a head positioned above the third portion.

8. The metal element of claim 6, wherein the first portion is threaded.

9. The metal element of claim 8, wherein the metal element is a special bolt for the positive coupling of a blade of a mowing machine to a rotating plate in order to rotate the blade.

10. The method of claim 2, wherein at least one portion of the blank is subjected to rolling in order to produce the threading, following the steps of cold pressing in dies.

11. The method of claim 2, wherein the blank is made from metal.

12. The method of claim 3, wherein the blank is made from metal.

13. The method of claim 10, wherein the blank is made from metal.

14. The element of claim 6 wherein the element is produced by means of a cold extrusion method in a die according to claim 1.

15. The element of claim 6 wherein the element is produced by means of a cold extrusion method in a die according to claim 2.

16. The element of claim 6 wherein the element is produced by means of a cold extrusion method in a die according to claim 3.

17. The metal element of claim 7, wherein the first potion is threaded.
